(19) United States
(12) Patent Application Publication
(10) Pub. No.: US 2004/0151833 A1
(43) Pub. Date: Aug. 5, 2004

(54) Method and device for applying carbon to a cathode ray tube funnel

(75) Inventors: Hiroji Morimoto, Kashihara-shi (JP); Kengo Kubo, Osaka-shi (JP)

Correspondence Address: MERCHANT & GOULD PC, P.O. BOX 2903, MINNEAPOLIS, MN, 55402-0903, US

(73) Assignee: MATSUSHITA ELECTRIC INDUSTRIAL CO., Kadoma-shi (JP)

(21) Appl. No.: 10/764,031

(22) Filed: Jan. 22, 2004

(30) Foreign Application Priority Data
Jan. 30, 2003 (JP) 2003-022728

(51) Int. Cl. B05D 5/06; B05D 5/12

(52) U.S. Cl. 427/230; 427/64; 118/300

(57) ABSTRACT

In applying an internal finishing carbon layer by flow-coating to an inner surface of a funnel of a cathode ray tube, when the internal finishing carbon poured onto the funnel's inner surface passes or after it has passed a region of the funnel at which a getter receptacle is provided, air is blown spotwise onto the internal finishing carbon. Thus, the amount of adhering internal finishing carbon in the region onto which air is blown can be reduced compared to the region onto which no air is blown.

### FIELD OF THE INVENTION

The present invention relates to a method and a device for applying carbon to a cathode ray tube funnel, in which carbon for internal finishing carbon is applied to the inner surface of funnels of cathode ray tubes (also referred to as CRTs), which are widely used as monitors of television receivers and various kinds of OA equipment, such as computer display monitors.

### BACKGROUND OF THE INVENTION

As shown in FIG. 5, cathode ray tubes are made of a panel portion 21, a funnel portion 22, and a neck portion 23. A phosphor layer 24 and a mask 25 providing a color discriminating function are arranged on the panel portion. An internal finishing carbon layer 26 serving as an internal conductive film and an anode button 27 supplying high voltage are arranged on the funnel portion 22. An electron gun 28 is arranged in the neck portion 23. The internal finishing carbon 26 layer that is applied as the internal conductive film to the inner surface of the funnel 22 is applied by flow coating, spraying or by application with a sponge or a brush.

However, in the case of application by spraying or with a brush, the adhesive strength of the internal finishing carbon film that is applied as the internal conductive film is not satisfactory, and ordinarily flow coating is employed as the method for applying the internal finishing carbon. To perform flow coating, the funnel 22 is put upright like a funnel, as shown in FIG. 6, and carbon 31 is flowed from a carbon dispensing nozzle 30 toward a location that is about 10 mm below the upper edge of the funnel 22 while rotating it once along the inner circumference of the funnel 22. The carbon 31 that flows out is collected from the neck portion 23, and the carbon that has adhered to the funnel 22 is fixed by drying with a heater.

On the other hand, the funnel 22 is provided with an anode button 27 for supplying a high voltage to the interior, and conduction must be established between this anode button 27 and the internal finishing carbon 26 layer. Moreover, a support rod 33 holding a getter receptacle 32 for ensuring the vacuum degree inside the tube is attached to the electron gun 28, as shown in FIG. 7. This getter receptacle 32 is in contact with the internal finishing carbon 26 layer via a plurality of springs 29, as shown in FIG. 8.

When the electron gun 28 is sealed into the neck portion 23, the plurality of springs 29 below the getter receptacle 32 are inserted while shaving off the internal finishing carbon 26. Moreover, when the CRT vibrates, the getter receptacle also will vibrate, so that the plurality of springs 29 shave off the internal finishing carbon 26. When the shaved off internal finishing carbon remains as dirt in the cathode ray tube, it may lead to damage such as causing a discharge inside the tube, thus lowering the reliability of the product. Consequently, it is necessary to reduce the amount of internal finishing carbon that is shaved off as dirt. However, when the internal finishing carbon in the region in which the getter receptacle vibrates is eliminated completely in order to eliminate the shaved off internal finishing carbon, then conduction with the internal finishing carbon of the surrounding portion is not established, so that immediately after a high voltage is applied via the anode button, the potential of the region where the getter receptacle is provided becomes different, so that the electron beam is bent, and it becomes difficult to provide a superior image.

JP H09-1999020A attempts to solve this problem, but a satisfactory solution has yet to be found.

### SUMMARY OF THE INVENTION

To solve the problems of the prior art, it is thus an object of the present invention to provide a method and a device for applying carbon to a cathode ray tube funnel with which it is possible to apply the layer of internal finishing carbon below the getter receptacle thinner than the layer of internal finishing carbon at the surrounding portions, when applying internal finishing carbon by flow coating to the inner surface of a funnel of a cathode ray tube.

According to one aspect of the present invention, a method for applying an internal finishing carbon by flow-coating to an inner surface of a funnel of a cathode ray tube is characterized in that, when the internal finishing carbon poured onto the funnel's inner surface passes or after it has passed a region of the funnel at which a getter receptacle is provided, air is blown spotwise onto the internal finishing carbon.

According to another aspect of the present invention, a method for applying an internal finishing carbon by flow-coating to an inner surface of a funnel of a cathode ray tube is characterized in that, when the internal finishing carbon poured onto the funnel's inner surface passes a region of the funnel at which a getter receptacle is provided, air is blown spotwise onto the internal finishing carbon. Then the blowing of air is temporarily stopped, and then air is blown again.

According to yet another aspect of the present invention, a device for applying an internal finishing carbon layer by flow-coating to an inner surface of a funnel of a cathode ray tube is characterized in that a nozzle for spotwise blowing of air onto a region of the funnel at which a getter receptacle is provided is attached to a nozzle for dispensing the internal finishing carbon, and the nozzles can be moved unitarily.

### BRIEF DESCRIPTION OF THE DRAWINGS

FIG. 1 is a perspective view illustrating a device for applying carbon to a cathode ray tube funnel according to an embodiment of the present invention.

FIG. 2 is a diagram showing a spot air nozzle according to an embodiment of the present invention.

FIG. 3 is a diagram showing how spot air is blown below the getter receptacle, according to an embodiment of the present invention.

FIG. 4 is a diagram showing the flow of the carbon under the blowing of spot air, according to an embodiment of the present invention.

FIG. 5 is a perspective view of a cathode ray tube according to a conventional example and an embodiment of the present invention.

FIG. 6 is a perspective view illustrating a method for applying carbon application by flow coating to a conventional cathode ray tube funnel.

FIG. 7 is a diagram showing how the getter receptacle is attached to the electron gun top portion in a conventional cathode ray tube funnel.

FIG. 8 is a diagram showing how the getter receptacle is in contact with the funnel in a conventional cathode ray tube funnel.

### DETAILED DESCRIPTION OF THE INVENTION

In a method for applying carbon to a cathode ray tube funnel according to the present invention, when the internal finishing carbon that is poured onto the inner surface of the funnel passes or after it has passed the region where the funnel's getter receptacle is provided, air is blown spotwise onto it. Thus, the amount of internal finishing carbon adhering to the region onto which air is blown can be reduced compared to the region onto which no air is blown.

In another application method according to the present invention, when the internal finishing carbon that is poured onto the inner surface of the funnel passes the region where the funnel's getter receptacle is provided, air is blown spotwise onto the internal finishing carbon, the blowing of air is temporarily stopped, and then air is blown again. Thus, the internal finishing carbon trickling from the upper edge of the funnel can be blown away again, so that the amount of internal finishing carbon adhering to the region onto which air is blown can be reduced compared to the region onto which no air is blown.

In the method for applying carbon to a cathode ray tube funnel according to the present invention, it is preferable that, in a region in which the getter receptacle is provided, the air is blown spotwise in a direction in which the internal finishing carbon is flowing. By blowing in a direction in which the internal finishing carbon is flowing in the region in which the getter receptacle is provided, the amount of adhering internal finishing carbon that has not yet dried and that is blown toward the upper edge of the funnel is small, and it becomes possible to prevent internal finishing carbon from again adhering to the region onto which air has been blown, thus making the amount of adhering internal finishing carbon smaller than that in the region onto which no air is blown.

In a device for applying internal finishing carbon to a funnel of a cathode ray tube in accordance with the present invention, a nozzle for spotwise blowing of air onto a region of the funnel at which a getter receptacle is provided is attached to a nozzle for dispensing the internal finishing carbon, and the nozzles can be moved unitarily. Thus, immediately after internal finishing carbon has been poured, it is possible to move the nozzles to the region onto which air is blown spotwise, without interference between the nozzle dispensing internal finishing carbon and the nozzle for spotwise blowing of air.

In the device for applying internal finishing carbon to a funnel of a cathode ray tube in accordance with the present invention, it is preferable that the nozzle for spotwise blowing of the air is a multi-hole nozzle comprising a plurality of micro-holes. The shape and the size of the region onto which air is blown as well as the thickness of the internal finishing carbon can be controlled appropriately by suitably arranging the plurality of micro-holes.

In the device for applying internal finishing carbon to a funnel of a cathode ray tube in accordance with the present invention, it is preferable that a nozzle blowing angle at which the air is blown spotwise is set to a range of 100° to 150° with respect to the funnel's inner surface. Thus, by setting the nozzle blowing angle at which the air is blown spotwise to a range of 100° to 150°, the amount of adhering internal finishing carbon that has not yet dried and that is blown toward the upper edge of the funnel becomes small, and it becomes possible to prevent internal finishing carbon from again adhering to the region onto which air has been blown, thus making the amount of adhering internal finishing carbon smaller than that in the region onto which no air is blown.

As explained above, with the method and the device for applying internal finishing carbon to a funnel of a cathode ray tube in accordance with the present invention, the layer of internal finishing carbon below the getter receptacle can be applied thinner than the layer of the internal finishing carbon at the surrounding portions. Consequently, conduction between the anode button and the internal finishing carbon can be established reliably, and a high voltage can be supplied to the inner portion of the funnel, while preventing the internal finishing carbon from being shaved off by the spring below the getter receptacle falling off when the electron gun is inserted into the neck portion or when the getter receptacle vibrates due to vibrations applied to the CRT, accumulating as dirt in the cathode ray tube and causing damage such as inducing discharges in the tube, so that the product quality of the cathode ray tube can be improved.

### EXAMPLE

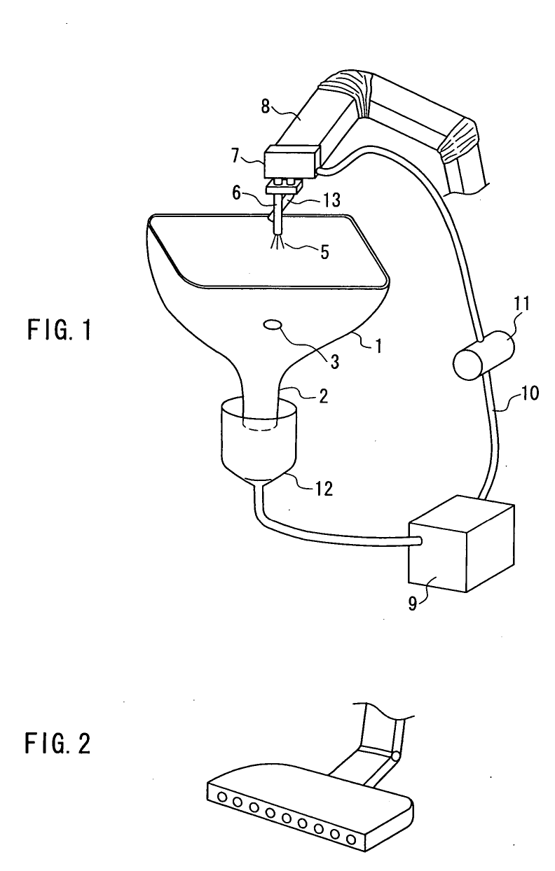

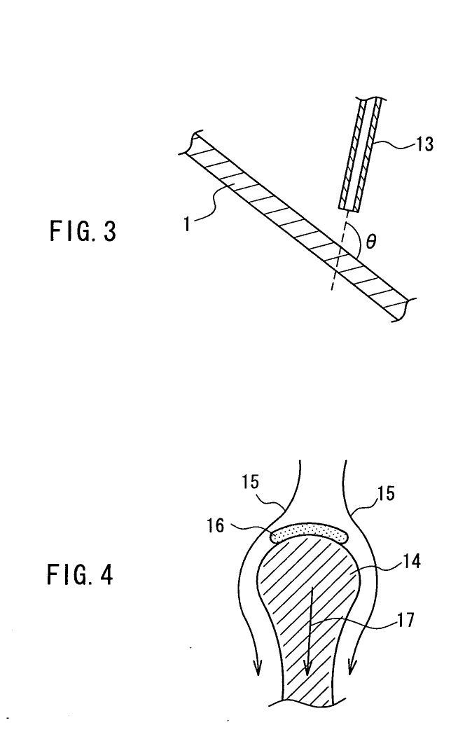

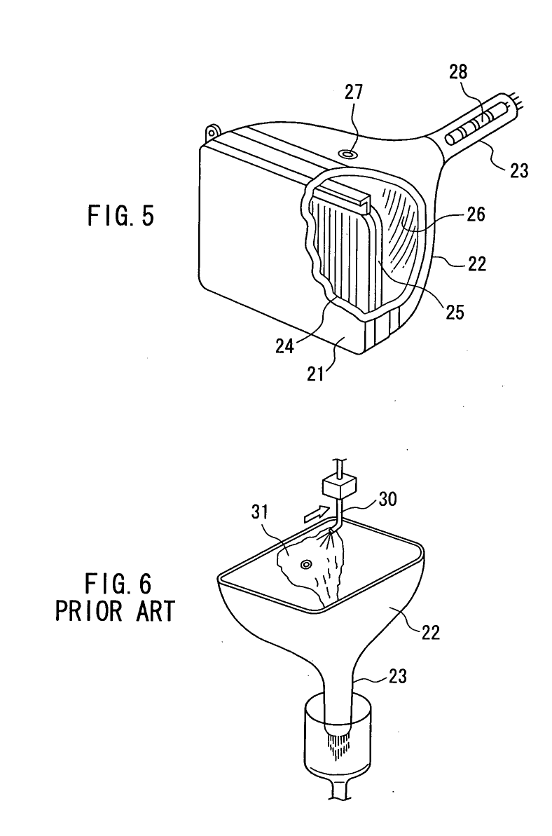

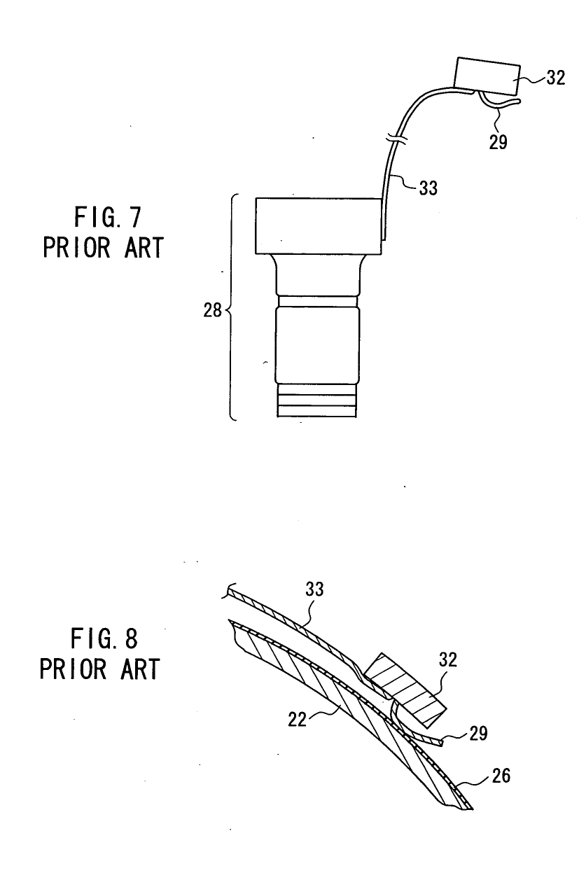

The following is a description of an embodiment of the present invention with reference to FIGS. 1 to 4. FIG. 1 is a perspective view illustrating the configuration of a device for applying carbon to a cathode ray tube funnel according to an embodiment of the present invention. FIG. 2 is a diagram showing the configuration of a spot air nozzle. FIG. 3 is a diagram showing how spot air is blown onto the region where there is no anode button and the getter receptacle is provided. FIG. 4 is a front view showing the flow of the carbon under the blowing of spot air.

In FIG. 1, a cathode ray tube according to an embodiment of the present invention includes a funnel portion 1 and a neck portion 2. The cathode ray tube is placed with the funnel upright in a cone receiver belonging to a transport palette (not shown in the drawings) and is transported to the internal finishing carbon application device. The anode button 3 arranged in the funnel 1 is provided in order to transmit a high voltage supplied from the outside to the inner surface of the funnel.

The internal finishing carbon application device is provided with a carbon nozzle 6, a carbon control valve 7, a multiaxial robot arm 8, a carbon tank 9 for holding internal finishing carbon 5, a hose 10, a carbon pump 11, and a collection tank 12. The carbon nozzle 6 pours the internal finishing carbon 5 toward a location about 10 mm below the upper edge of the inner surface of the funnel 1, which has been set up as described above. The carbon control valve 7 controls the dispensing of the internal finishing carbon 5. The multiaxial robot arm 8 moves the carbon nozzle 6 and the carbon control valve 7. The carbon pump 11 supplies the internal finishing carbon 5 stored in the carbon tank 9 via the hose 10 to the carbon control valve 7 and the carbon dispensing nozzle 6. The carbon collection tank 12 collects the internal finishing carbon 5 that flows down the inner surface of the funnel 1 and out through the neck portion 2 at the bottom.

A spot air nozzle 13 is attached to and supported by the carbon dispensing nozzle 6, such that the carbon dispensing nozzle 6 and the spot air nozzle 13 can be moved unitarily, and is arranged such that it can be moved by the multiaxial robot arm 8 to the air blowing region immediately after the carbon pouring has finished, without interference of the carbon dispensing nozzle. The tip of the spot air nozzle 13 is made of a round hole of about φ15 mm diameter. A preferable discharge pressure is 0.08 to 0.15 MPa. Alternatively, the spot air nozzle 13 can be made of a plurality of micro-nozzles that are arranged in horizontal direction, as shown in FIG. 2, so as to blow air onto the entire region 14 (shown in FIG. 4) over which the getter receptacle provided inside the funnel 1 vibrates in horizontal direction. Moreover, as shown in FIG. 3, the spot air nozzle 13 is positioned at a location that is about 30 to 50 mm removed from the inner surface of the funnel 1, setting the air blowing angle θ to the inner surface of the funnel to 100° to 150°.

When using this application device to apply the internal finishing carbon 5 to the inner surface of the funnel 1, first, the carbon nozzle 6 to which the spot air nozzle 13 is attached is moved by the multiaxial robot arm 8 to the upper edge portion of the funnel 1 at the region where the getter receptacle is provided, the carbon control valve 7 is opened, and the internal finishing carbon 5 is applied to the inner surface of the funnel 1. Immediately after the carbon nozzle 6 has been rotated once along the upper edge of the funnel 1 (the internal finishing carbon is applied to the entire inner surface of the funnel, but the internal finishing carbon 5 is still flowing along the inner surface of the funnel 1), the carbon nozzle 6 to which the spot air nozzle 13 is attached is moved to the region where the getter receptacle is provided, air is blown spotwise in the direction in which the internal finishing carbon flows, as shown in FIG. 4, most of the internal finishing carbon is blown away, and the amount of internal finishing carbon is reduced compared to the region onto which no air is blown. FIG. 4 shows the state in which a flow of internal finishing carbon 15 occurs in the air blowing region 14, and carbon 16 is blown toward the upper edge of the funnel by air 17.

Now, the air blowing angle θ is set to 100° to 150° as noted above, so that most of the internal finishing carbon that is blown away flows toward the neck portion 2, but there is internal finishing carbon 16 that is blown toward the upper edge of the funnel 1, depending on such parameters as the viscosity of the internal finishing carbon 5, the blowing angle θ and the pressure of the spot air nozzle 13, or the temperature of the funnel 1 and the internal finishing carbon 5. The internal finishing carbon 16 that is blown toward the upper edge of the funnel 1 trickles down again to the region onto which air has been blown, so that it is necessary to keep blowing until the internal finishing carbon has completely dried. However, at the upper edge of the region onto which air is blown with the above-described method, the air stream forms a wall, and the internal finishing carbon that does not trickle down may form a layer that is thicker than at the regions onto which no air is blown. When the funnel 1 is bonded to the panel or when it is passed as a cathode ray tube through a furnace to evacuate air, then this thick layer of internal finishing carbon tends to fall off from the funnel 1. The internal finishing carbon that has come off leads to damage such as causing a discharge inside the tube and lowers the reliability of the product, so that immediately after the carbon nozzle 6 has been rotated once along the upper edge of the funnel 1, the carbon nozzle 6 to which the spot air nozzle 13 is attached is moved to the region where the getter receptacle is provided, and air is blown after waiting for about 0.5 to 2 sec, when most of the internal finishing carbon has trickled down. With this method, there is little internal finishing carbon trickling down, even when the air stream forms a wall, so that it is possible to reduce the amount of adhering internal finishing carbon compared to that of the region onto which no air is blown, without forming a thick layer of internal finishing carbon.

Alternatively, immediately after the carbon nozzle 6 has been rotated once along the upper edge of the funnel 1, the carbon nozzle 6 to which the spot air nozzle 13 is attached is moved to the region where the getter receptacle is provided, air is blown spotwise, and the blowing of air is stopped temporarily while the internal finishing carbon has not yet dried. The internal finishing carbon that has remained without trickling down comes trickling down to the region onto which air is blown, and by blowing air once again. Thus, the internal finishing carbon that trickles down to the air-blowing region after the blowing of air has been stopped can be spread thinly by once again blowing air, so that the amount of adhering internal finishing carbon can be reduced compared to that of the region onto which no air is blown.

Thus, with the above-described embodiment, it is possible to apply a layer of internal finishing carbon that is thinner than the surrounding portion to the region where the getter receptacle is arranged on the side where the anode button 3 of the funnel 1 is not. Moreover, depending on the position where the getter receptacle is arranged, when the layer of internal finishing carbon at the surrounding portion onto which no air is blown has a dry thickness of about 20 to 40 μm and the dry thickness of the internal finishing carbon at the region onto which air is blown is at least 5 μm, then reliable conduction is possible.

The invention may be embodied in other specific forms without departing from the spirit or essential characteristics thereof The embodiments disclosed in this application are to be considered in all respects as illustrative and not restrictive, the scope of the invention being indicated by the appended claims rather than by the foregoing description. All changes that come within the meaning and range of equivalency of the claims are intended to be embraced therein.

What is claimed is:

1. A method for applying an internal finishing carbon layer by flow-coating to an inner surface of a funnel of a cathode ray tube, wherein, when the internal finishing carbon poured onto the funnel's inner surface passes or after it has passed a region of the funnel at which a getter receptacle is provided, air is blown spotwise onto the internal finishing carbon at the region at which a getter receptacle is provided.

2. The method for applying carbon to a cathode ray tube funnel according to claim 1, wherein the air is blown spotwise in a direction in which the internal finishing carbon is flowing.

3. The method for applying carbon to a cathode ray tube funnel according to claim 1, wherein a nozzle blowing angle at which the air is blown spotwise is set to a range of 100° to 150° with respect to the funnel's inner surface.

4. The method for applying carbon to a cathode ray tube funnel according to claim 1, wherein a nozzle for spotwise blowing of the air is a multi-hole nozzle comprising micro-holes.

5. A method for applying an internal finishing carbon by flow-coating to an inner surface of a funnel of a cathode ray tube,
wherein when the internal finishing carbon poured onto the funnel's inner surface passes a region of the funnel at which a getter receptacle is provided, air is blown spotwise onto the internal finishing carbon, then the blowing of air is temporarily stopped, and then air is blown again.

6. The method for applying carbon to a cathode ray tube funnel according to claim 5, wherein the air is blown spotwise in a direction in which the internal finishing carbon is flowing.

7. The method for applying carbon to a cathode ray tube funnel according-to claim 5, wherein a nozzle blowing angle at which the air is blown spotwise is set to a range of 100° to 150° with respect to the funnel's inner surface.

8. The method for applying carbon to a cathode ray tube funnel according to claim 5, wherein a nozzle for spotwise blowing of the air is a multi-hole nozzle comprising micro-holes.

9. A device for applying an internal finishing carbon layer by flow-coating to an inner surface of a funnel of a cathode ray tube, wherein a nozzle for spotwise blowing of air onto a region of the funnel at which a getter receptacle is provided is attached to a nozzle for dispensing the internal finishing carbon, and the nozzles can be moved unitarily.

10. The device for applying carbon to a cathode ray tube funnel according to claim 9, wherein the nozzle for spotwise blowing of the air is a multi-hole nozzle comprising micro-holes.

11. The device for applying carbon to a cathode ray tube funnel according to claim 9, wherein a nozzle blowing angle at which the air is blown spotwise is set to a range of 100° to 150° with respect to the funnel's inner surface.
